(19) United States
(12) Patent Application Publication
(10) Pub. No.: US 2017/0308519 A1
(43) Pub. Date: Oct. 26, 2017

(54) LEARNING SEMANTIC PARSING

(71) Applicant: Google Inc., Mountain View, CA (US)

(72) Inventors: Fuchun Peng, Cupertino, CA (US); Ben Shahshahani, Menlo Park, CA (US); Howard Scott Roy, Palo Alto, CA (US)

(21) Appl. No.: 13/922,438

(22) Filed: Jun. 20, 2013

(51) Int. Cl. G06F 17/27

(52) U.S. Cl. CPC G06F 17/271

(57) ABSTRACT

A server accesses an initial query associated with a classification, the classification corresponding to a likely intent of the initial query. The server obtains a set of queries, wherein each query in the set of queries is identified as having resulted in one or more users selecting a resource that was selected by one or more users in response to submitting the initial query. The server then determines a metric for one or more queries in the set of queries, wherein the metric for each of the one or more queries in the set of queries is based on a similarity between the respective query and the initial query. Next, the server selects a subset of queries from the set of queries based on the metric for each selected query satisfying a threshold and associates the selected subset of queries with the classification of the initial query.

### TECHNICAL FIELD

This specification generally relates to natural language processing.

### BACKGROUND

Semantic parsing techniques may rely on manually generated examples to generate a suitable grammar. For example, to develop a grammar to recognize a query, human writers may generate and label numerous questions. Such manual processes may be expensive and time-consuming.

### SUMMARY

The subject matter described in this specification may alleviate some of these issues by automatically extracting training examples. For example, based on a few example queries or resources with known classifications, large amounts of examples can be extracted from historical query data. The extracted examples may then be classified according to likely intent and used to induce grammars for parsing subsequent queries.

In general, one aspect of the subject matter includes the actions of accessing an initial query associated with a classification, the classification corresponding to a likely intent of the initial query. The actions also include obtaining a set of queries, wherein each query in the set of queries is identified as having resulted in one or more users selecting a resource that was selected by one or more users in response to submitting the initial query and determining a metric for one or more queries in the set of queries, wherein the metric for each of the one or more queries in the set of queries is based on a similarity between the respective query and the initial query. The actions then include selecting a subset of queries from the set of queries based on the metric for each selected query satisfying a threshold and associating the selected subset of queries with the classification of the initial query. In some implementations, the actions also include providing the selected subset of queries for inducing a grammar for semantic parsing related to the classification. In some implementations, the actions include extracting a set of patterns from the selected subset of queries and generating a grammar for semantic parsing based on the set of patterns.

Some implementations involve an initial web search query associated with a classification, where the classification corresponds to a likely intent of the initial web search query. In such implementations, each query in the set of queries is a web search query, and each query in the set of web search queries is identified as having resulted in one or more users selecting a web page that was selected by one or more users in response to submitting the initial web search query.

Some implementations involve an initial command associated with a classification, where the classification corresponds to a likely intent of the initial command. In such implementations, each query in the set of queries is a command, and each command in the set of commands is identified as having resulted in one or more users selecting an action that was selected by one or more users during a session in which the one or more users submitted the initial command. In some aspects, each command in the set of commands is identified as having resulted in one or more users selecting an action that was selected by one or more users in response to submitting the initial command.

Some implementations involve determining a cosine similarity between resources selected in response to the respective query and resources selected in response to the initial query.

Another aspect of the subject matter includes the actions of accessing a resource associated with a semantic classification. The actions also include obtaining a set of queries, wherein each query in the set of queries is identified as having resulted in one or more users selecting the resource and determining a metric for one or more queries in the set of queries, wherein the metric for each of the one or more queries in the set of queries is based on a level of correlation between the respective query and the resource. Then, the actions include selecting a subset of queries from the set of queries based on the metric for each selected query exceeding a threshold and associating the selected subset of queries with the semantic classification of the resource. Some implementations include the additional action of providing the selected subset of queries for inducing a grammar for semantic parsing related to the semantic classification. Some implementations include the additional actions of extracting a set of patterns from the selected subset of queries and generating a grammar for semantic parsing based on the set of patterns.

Some implementations involve determining a frequency of users selecting the resource in response to the respective query compared to a frequency of users selecting other resources in response to the respective query.

Some implementations involve a webpage associated with a semantic classification. In such implementations, obtaining a set of queries may involve obtaining a set of web search queries, wherein each web search query in the set of web search queries is identified as having resulted in one or more users selecting the webpage. Some implementations involve an action associated with a semantic classification. In such implementations, obtaining a set of queries may involve obtaining a set of commands, wherein each command in the set of commands is identified as having resulted in one or more users selecting the action during a session. In some aspects, each command in the set of commands is identified as having resulted in one or more users selecting the action in response to submitting each respective command.

Implementations described in this specification may realize one or more of the following advantages. In some implementations, data mined from the World Wide Web or similar semi-structured or weakly structured collections of documents can be used to automatically or semi-automatically induce grammars for parsing and interpreting subsequent queries and commands.

The details of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example system that automatically generates and classifies training examples of queries for use in inducing grammars.

FIGS. 2A and 2B are diagrams illustrating example processes for automatically generating and classifying training examples of queries.

FIG. 3 is a flowchart of an example process for automatically generating and classifying training examples of queries based on an initial query.

FIG. 4 is a flowchart of an example process for automatically generating and classifying training examples of queries based on an initial resource.

Like reference numbers and designations in the various drawings indicate like elements.

### DETAILED DESCRIPTION

Queries may include natural language queries, some of which may be knowledge or action queries. For example, knowledge queries may include queries such as “how is the weather in San Francisco,” “how old is Barack Obama,” or “movies made by Ang Lee.” Example action queries may include “show me how to get to San Francisco,” “what's on my calendar for tomorrow,” or “reserve a flight to Seattle.” Inducing grammars for parsing such queries may require numerous training examples, which may be time-consuming and expensive to generate. The subject matter described in this specification includes techniques for automatically extracting training examples from collections of data. For example, by providing one or more seed queries or seed resources that are classified according to likely intent, a system may mine large amounts of examples similar to the seed queries or seed resources automatically. The system can then semantically classify the mined examples based on the classification of the seed queries or seed resources, and induce a grammar based on the classified examples.

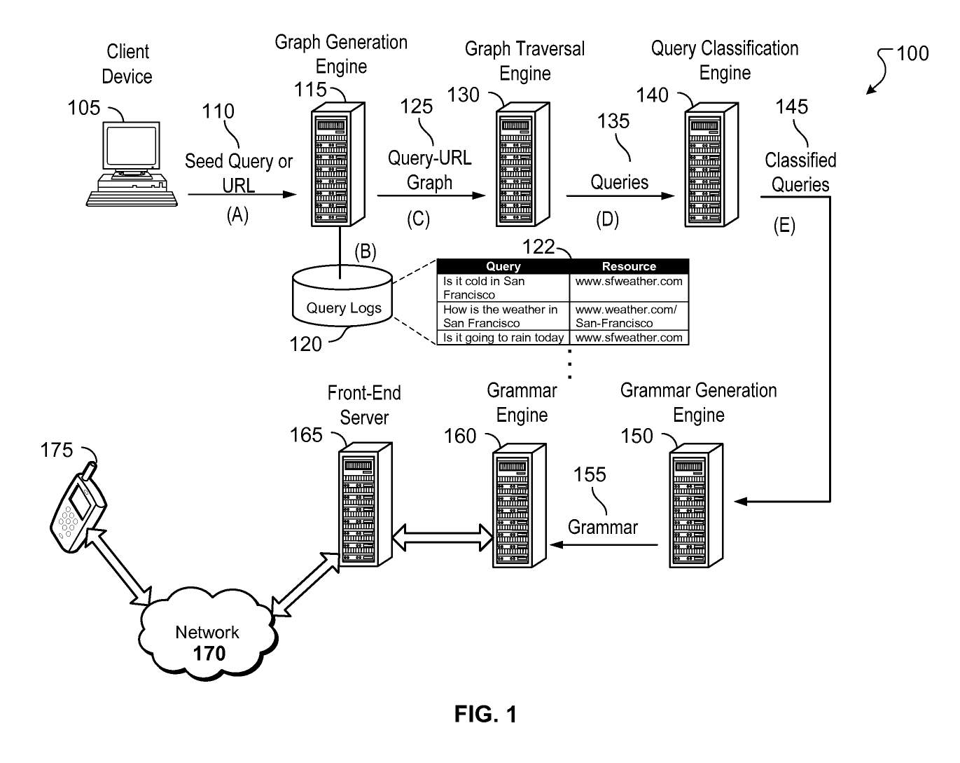

FIG. 1 shows an example system 100 that automatically generates and classifies training examples of queries for use in inducing grammars. As an overview, the system 100 includes a client device 105, a graph generation engine 115, a graph traversal engine 130, and a query classification engine 140. The graph generation engine 115, graph traversal engine 130, and query classification engine 140 may be processing system that take the form of a number of different devices, for example a standard server, a group of such servers, or a rack server system. In addition, graph generation engine 115, graph traversal engine 130, and query classification engine 140 may be implemented in a personal computer, for example a laptop computer. In some implementations, two or more of the graph generation engine 115, graph traversal engine 130, and query classification engine 140 may be implemented on the same processing system or on different processing systems.

As used in this specification, an “engine” (or “software engine”) refers to a software implemented input/output system that provides an output that is different from the input. An engine can be an encoded block of functionality, such as a library, a platform, a Software Development Kit (“SDK”), or an object.

In operation, the client device 105 provides a seed query or seed resource, e.g., uniform resource locator (URL) 110, to the graph generation engine 115. This seed query or seed URL may be associated with an initial classification that corresponds to a likely intent or semantic classification of the seed query or seed URL. The graph generation engine 115 analyzes query logs 120 to produce a query-URL graph 125.

The graph generation engine 115 provides the query-URL graph 125 to the graph traversal engine 130, which traverses the graph to identify queries that are related to the seed query or seed URL 110. For example, as described in more detail below, the graph traversal engine 130 may determine a similarity metric between each identified query and the seed query. If the similarity metric satisfies a threshold, then the graph traversal engine 130 identifies the respective query as being related to the seed query. Alternatively or in addition, the graph traversal engine 130 may determine a correlation metric between each identified query and a seed URL. If the correlation metric satisfies a threshold, then the graph traversal engine 130 identifies the respective query as being related to the seed URL.

The graph traversal engine 130 then provides the identified queries to the query classification engine 140. The query classification engine 140 classifies the identified queries according to the classification of the seed query or seed URL and provides the classified queries 145 to a grammar generation engine 150. The grammar generation engine 150 then induces a grammar 155 based on the classified queries 145 and provides the grammar to a grammar engine 160. In some implementations, the processes performed by the graph generation engine 115, graph traversal engine 130, query classification engine 140, and grammar generation engine 150 may be performed off-line, e.g., in a back-end training mode.

The induced grammar 155 may be used for responding to queries. For example, when a client device 175 submits a query to front end server 165 via network 170, the front end server 165 may access the grammar from the grammar engine 160 to parse and respond to the query.

FIG. 1 also shows an example flow of data, shown in stages (A) to (E). Stages (A) to (E) may occur in the illustrated sequence, or they may occur in a sequence that is different than in the illustrated sequence. In some implementations, one or more of the stages (A) to (E) may occur offline.

In stage (A), a client device 105 provides a seed query or seed resources 110 to a graph generation engine 115. The client device 110 may include one or more processing devices, and may be, or include, a desktop computer, a server, a mobile telephone (e.g., a smartphone), a laptop computer, a handheld computer, a tablet computer, a network appliance, a camera, a media player, a wearable computer, a navigation device, an email device, a game console, an interactive television, or a combination of any two or more of these data processing devices or other data processing devices.

A seed query may be a query associated with a predetermined classification. In some implementations, the seed query may be a knowledge-seeking query on a topic such as celebrities or politics. In such implementations, the seed query may be a web search query. Alternatively or in addition, the seed query may be a command to initiate an action related to an application such as, for example, a command to search a map, to view a calendar, or to transmit an email.

A seed resource may be, for example, a resource associated with a predetermined classification, e.g., a semantic category such as celebrities, politics, maps or weather. In some implementations, a seed resource may be a webpage. Alternatively or in addition, a seed resource may be an action initiated in response to a command, for example, a user selecting a map application, a calendar application, or an email application.

In stage (B), upon receiving the seed query or seed URL 110, the graph generation engine 115 accesses query logs 120 to generate a query-URL graph. The query logs 120 may be, for example, a database or set of databases, a flat file or set of flat files, or any suitable combination thereof. The query logs 120 may be, for example, a table 122 as shown in FIG. 1 that includes previous queries from users in one column, and the resource selected or clicked on by the users after submitting the queries in another column. In the example illustrated in table 122, a user may have entered the query “is it cold in San Francisco” and subsequently selected a resource identified as “www.SFweather.com” from the provided search results. Another user may have entered the query “is it cold in San Francisco” and subsequently selected the resource identified as “www.weather.com/San-Francisco” from the provided search results. Yet another user may have entered the query “how is the weather in San Francisco” and subsequently selected the resource identified as “www.SFweather.com” from the provided search results.

A resource may, but need not, correspond to a file. A resource may be stored in a portion of a file that holds other resources, in a single file dedicated to the resource, or in multiple coordinated files. In some implementations, resources are web pages (e.g., markup language documents such as Hypertext Markup Language documents). Other types of resources, for example, images and videos, are also possible. As another example, a resource may be an application configured to perform an action.

The query-URL graph may be any suitable data structure that associates queries with URLs. For example, the query-URL graph may be a bipartite graph having one set of vertices corresponding to queries, and another set of vertices corresponding to URLs. Each edge in the bipartite graph may correspond to a click by a user on a URL after entering the associated query. The graph generation engine 115 may access the query logs 120 in any suitable manner to generate the query-URL graph. For example, for a given query, the graph generation engine 115 may determine that a resource was selected immediately in response to the query, e.g., a user's first click or interaction after submitting the query was to select the resource. Alternatively or in addition, the graph generation engine 115 may perform session analysis to generate the query-URL graph. For example, for a given query such as a web search query or a command, the graph generation engine 1115 may determine based on the query logs 120 that a resource was selected during a user's session, e.g., within a predetermined number of clicks or interactions after submitting the query. The graph generation engine 115 could then add a corresponding query-URL edge to the query-URL graph.

In stage (C), the graph traversal engine 130 receives the query-URL graph 125, and traverses the graph to obtain a set of queries related to the seed query or seed URL 110. For example, the graph traversal engine may perform a breadth first traversal of the query-URL graph.

In some implementations, given a seed query that resolved to a set of URLs at certain frequencies, the graph traversal engine 130 may traverse the query-URL graph and identify other queries that also resolved to those URLs with similar frequencies. For example, the graph traversal engine 130 may identify queries having a similarity metric exceeding a predetermined threshold, where the similarity metric is based on a similarity between the seed query and each respective query.

The similarity metric may be based in part on a cosine similarity between a vector representing the seed query and a vector representing each respective query. The components of each vector may correspond to, for example, edges in the query-URL graph associated with the queries being compared, i.e., counts of selections of resources associated with each query. For example, assume the seed query “is it cold in San Francisco” resolved to a first resource “www.SFweather.com” with a count of 100 and to a second resource “www.weather.com/San-Francisco” with a count of 200. In other words, assume that 100 users entered the query “is it cold in San Francisco” and selected the website “www.SFweather.com” and 200 users entered the query “is it cold in San Francisco” and selected the website “www.weather.com/San-Francisco.” Assume that another query resolved to the “www.SFweather.com” resource with a count of 100, resolved to the “www.weather.com/San Francisco” resource with a count of 100, and resolved to a third resource “www.weather.san-francisco” with a count of 100. Thus, the graph traversal engine 130 could compute a cosine similarity between the vector <100, 200, 0> for the seed query and the vector <100, 100, 100> for the other query. In this case, the cosine similarity between the vectors would be approximately 0.77.

In some implementations, given a seed URL, the graph traversal engine 130 may traverse the query-URL graph and identify queries that are highly correlated with the seed URL. For example, the graph traversal engine 130 may identify queries having a correlation metric exceeding a predetermined threshold, where the correlation metric is based on a correlation between the seed URL and each respective query. This correlation metric may be based in part on a number of edges between the seed URL and the respective query, i.e., a number of instances when a user entered the respective query and then selected the seed URL. Alternatively or in addition, the correlation metric may be based in part on the number of instances where a user entered the respective query and then selected a URL other than the seed URL. Alternatively or in addition, the correlation metric may be derived from a ratio of these two calculations, e.g., a number of instances when a user entered the respective query and selected the seed URL versus the number of instances when a user entered the respective query and selected another URL. Furthermore, some implementations may involve a correlation metric based in part on the number of instances when a user entered the respective query and selected the seed URL versus the total number of instances when users entered the respective query.

Suitable values for thresholds for the similarity metric and/or the correlation metric may be implementation specific. For example, in some implementations, the threshold for the similarity metric and/or the correlation metric may be determined empirically. In some implementations, the thresholds for the similarity metric and/or the correlation metric may be normalized to a value between 0 and 1. In such implementations, the threshold could be any suitable value such, for example, 0.5, 0.6, 0.7, 0.8, or 0.9.

In stage (D), the query classification engine 140 receives the queries 135 identified by the graph traversal engine 130 and associates the queries with a classification. In some implementations, given a seed query associated with an initial classification corresponding to a likely intent of the seed query, the query classification engine 140 may classify each identified query with the same classification as the seed query. Alternatively or in addition, given a seed URL associated with an initial classification corresponding to a semantic category of the seed URL, the query classification engine 140 may classify each identified query with the same classification as the seed URL. The query classification engine 140 then provides the classified queries 145 to the grammar generation engine 150 in stage (E). These classified queries represent training examples that the grammar generation engine 150 may use to induce a grammar relating to the classification of the seed query and/or seed URL.

The grammar engine 150 may induce grammar relating to the classification of the seed query or seed URL in any suitable manner. For example, the grammar engine 150 may identify a set of patterns in the classified queries. The set of patterns may be based on, for example, a frequency of occurrence of a particular phrase or phrases in the classified queries. The grammar engine 150 may then generate the grammar based on the identified frequency of occurrence of the particular phrase or phrases. In some implementations, the grammar engine 150 may normalize a phrase or phrases before identifying the frequency of occurrence of the particular phrase or phrases from the classified queries. The grammar engine 150 may normalize the phrase or phrases by removing one or more terms from the phrase or phrases, substituting a term in the phrase or phrases with a substituted term, reordering the terms in the phrase or phrases, or adding one or more terms to the phrase or phrases. After inducing a grammar, the grammar engine 150 may provide the grammar 155 to a grammar engine 160 or to a storage device accessible to the grammar engine 160.

At run time, a client device 175 may submit a query to the front end server 165 via the network 170. The client device 175 may include one or more processing devices, and may be, or include, a desktop computer, a mobile telephone (e.g., a smartphone), a laptop computer, a handheld computer, a tablet computer, a network appliance, a camera, a media player, a wearable computer, a navigation device, an email device, a game console, an interactive television, or a combination of any two or more of these data processing devices or other data processing devices. The network 170 can include, for example, a wireless cellular network, a wireless local area network (WLAN) or Wi-Fi network, a Third Generation (3G) or Fourth Generation (4G) mobile telecommunications network, a wired Ethernet network, a private network such as an intranet, a public network such as the Internet, or any appropriate combination thereof. The front end server 165 may be, for example, a web server or an application server.

Upon receiving the query, the front end server 165 transmits the query to grammar engine 160. The grammar engine 160 then parses the query using one or more stored grammars to determine an appropriate response. For example, if the grammar engine 160 determines that the query is a web query based on the grammars, the grammar engine may initiate a process to retrieve responsive search results. If the grammar engine 160 determines that the query is a command based on the grammars, the grammar engine may initiate an appropriate action. Sample actions may include, for a map command, transmitting the command to a map application; for an email command, transmitting the command to an email application; or for a calendar command, transmitting the command to a calendar application.

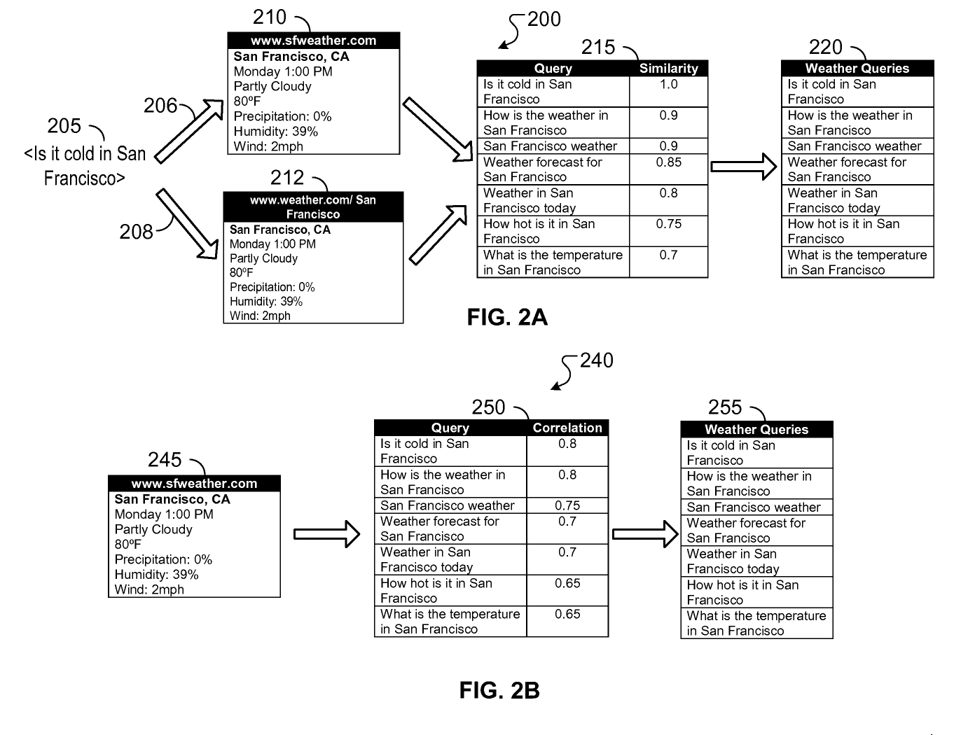

FIGS. 2A and 2B illustrate example processes 200, 240 for automatically generating and classifying training examples of queries. The processes 200, 240 may be performed, for example, by the graph engine 115, the graph traversal engine 130, and the query classification engine 140 shown in FIG. 1.

FIG. 2A illustrates a process 200 that begins with a seed query associated with a classification, e.g., a weather query. The seed query 205 (“is it cold in San Francisco”) resulted in the selection of two resources, a first webpage 210 with a URL of “www.SFweather.com” and a second webpage 212 with a URL of “www.weather.com/San-Francisco.” The arrow 206 represents the number of instances where a user entered the seed query 205 and selected the first webpage 210, and the arrow 208 represents the number of instances where user entered the seed query 205 and selected the second webpage 212.

Based on a vector representing the seed query 205, the graph traversal engine 130 then may determine cosine similarities between the seed query and other queries. For example, the graph traversal engine 130 may generate a table 215 ranking other queries against the seed query based on cosine similarities. The sample table 215 includes the query “is it cold in San Francisco” with the similarity of 1.0 indicating that the query is identical to the seed query. Sample table 215 includes other queries that are also similar to the seed query, for example, “how is the weather in San Francisco” with the similarity of 0.9, “San Francisco weather” with similarity of 0.9, “weather forecast for San Francisco” with similarity of 0.85, “weather in San Francisco today” with the similarity of 0.8, “how hot is it in San Francisco” with the similarity of 0.75, and “what is the temperature in San Francisco” with similarity of 0.7.

Using the determined similarities, the queries are then classified according to the classification of the seed query, i.e., as weather queries 220. For example, the query classification engine 140 may associate all of the queries received from the graph traversal engine with the classification of the seed query. In some implementations, the query classification engine 140 may receive a set of query-similarity pairs and classify only the queries having a similarity that exceeds a threshold. Alternatively or in addition, the graph traversal engine 130 may perform a threshold function and only transmit queries having a similarity exceeding a threshold to the query classification engine 140.

FIG. 2B illustrates a process 240 that begins with a seed URL associated with a semantic classification, e.g., a weather-related resource. The graph traversal engine 130 determines correlations of queries to the seed URL 245 by traversing a query-URL graph. The correlation metrics may be based on the number of instances when a user enters a given query and selects the seed URL 245. In some implementations, the correlation metrics may also take into account the number of instances when a user enters a given query and does not select the seed URL 245. The graph traversal engine 130 may generate a table 250 ranking queries based on correlation metrics. The sample table 250 indicates that the query “is it cold in San Francisco” has a correlation metric of 0.8 with the seed URL 245, the query “how is the weather in San Francisco” has a correlation metric of 0.8 with the seed URL 245, the query “San Francisco weather” has a correlation metric of 0.75 with the seed URL 245, the query “weather forecast for San Francisco” has a correlation metric of 0.7 with the seed URL 245, the query “weather in San Francisco today” has a correlation metric of 0.7 with the seed URL 245, the query “how hot is it in San Francisco” has a correlation metric of 0.65 with the seed URL 245, and the query “what is the temperature in San Francisco” has a correlation metric of 0.65 with the seed URL 245. As described above, the graph traversal engine 130 and/or the query classification engine 140 may use a threshold to classify the most highly correlated queries with the semantic classification of the seed query 245, thus generating a list 255 of weather-related queries.

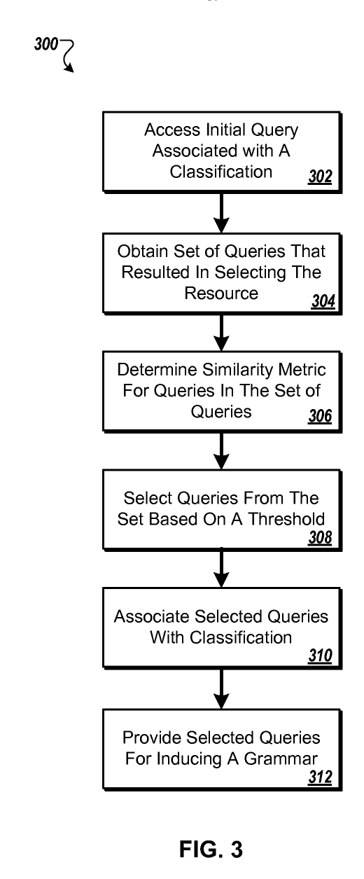

FIG. 3 shows an example process 300 for automatically generating and classifying training examples of queries based on an initial query. The process 300 will be described as being performed by a processing system such as a server or set of servers including one or more processors, for example, the graph generation engine 115, the graph traversal engine 130, and the query classification engine 140 as shown in FIG. 1. While the steps are illustrated in a particular sequence in FIG. 3, the steps may be implemented in any suitable sequence.

In step 302, the processing system accesses an initial query, e.g., a seed query, associated with a classification. The classification corresponds to a likely intent of the initial query. The initial query may be, for example, a web search query or a command to perform an action.

In step 304, the processing system obtains a set of queries. Each query in the set of queries is identified as having resulted in one or more users selecting a resource that was also selected by one or more users in response to submitting the initial query. For example, if the initial query is a web search query, the processing system may obtain a set of web search queries that resulted in a user selecting a webpage that was also selected in response to a user submitting the initial web search query. If the initial query is a command, the processing system may obtain a set of commands that resulted in a user selecting an action that was also selected in response to user submitting the initial command. Some implementations may involve performing session analysis to determine that a resource was selected in response to submitting a query. For example, for a given query such as a web search query or a command, the processing system may determine that a resource was selected during a user's session, e.g., within a predetermined number of clicks or interactions after submitting the query. Alternatively or in addition, for a given query, the processing system may determine that a resource was selected immediately in response to the query, e.g., a user's first click or interaction after submitting the query was to select the resource.

Next, the processing system determines a metric for each the queries in the set of queries in step 306. The metric may be based on a similarity between each respective query and the initial query. In some implementations, the metric may be a cosine similarity between the initial query and other queries, where the vector components of the initial query and each respective query correspond to instances of users entering the initial query and the respective query and selecting resources as a result. Then, in step 308, the processing system selects a subset of queries from the set of queries based on determining whether the metric associated with each query satisfies a threshold.

The processing system then associates the queries in the selected subset of queries with the classification of the initial query in step 310. The processing system then provides the selected subset of queries for inducing a grammar in step 312. The grammar may be used for semantic parsing related to the classification of the initial query. For example, the grammar generation engine 150 shown in FIG. 1 may extract a set of patterns from the selected subset of queries and then generate a grammar for semantic parsing based on the set of patterns.

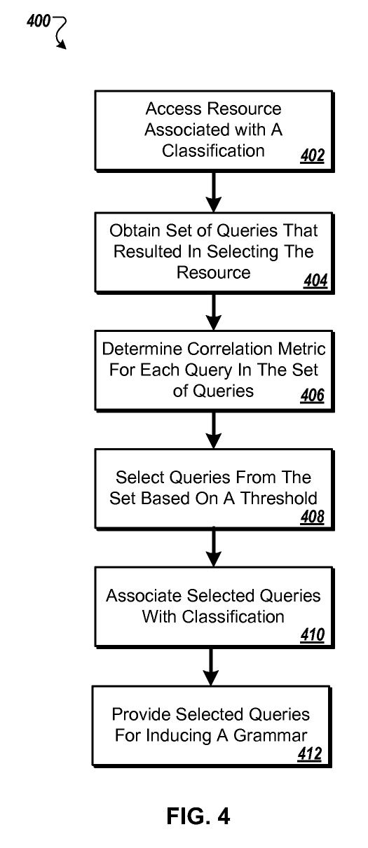

FIG. 4 shows an example process 400 for automatically generating and classifying training examples of queries based on an initial resource. The process 400 will be described as being performed by a processing system such as a server or set of servers that includes one or more processors, for example, the graph generation engine 115, the graph traversal engine 130, and the query classification engine 140 as shown in FIG. 1. While the steps are illustrated in a particular sequence in FIG. 4, the steps may be implemented in any suitable sequence.

In step 402, the processing system accesses an initial resource, e.g., a seed URL, associated with a semantic classification. The classification corresponds to a semantic category of the initial resource. The initial resource may be, for example, a web page or an application corresponding to an action.

In step 404, the processing system obtains a set of queries. Each query in the set of queries is identified as having resulted in one or more users selecting a resource that was also selected by one or more users in response to submitting the initial query. For example, if the initial resource is a webpage, the processing system may obtain a set of web search queries that resulted in a user selecting that webpage. If the initial resource is an action, the processing system may obtain a set of commands that resulted in a user selecting that action. Some implementations may involve performing session analysis to determine that a resource was selected in response to submitting a query. For example, for a given query such as a web search query or a command, the processing system may determine that a resource was selected during a user's session, e.g., within a predetermined number of clicks or interactions after submitting the query. Alternatively or in addition, for a given query, the processing system may determine that a resource was selected immediately in response to the query, e.g., a user's first click or interaction after submitting the query was to select the resource.

Next, the processing system determines a metric for each of the queries in the set of queries in step 406. The metric may be based on a correlation between each respective query and the initial resource. In some implementations, the metric may be based in part on a frequency at which a user entered the respective query and selected the initial resource. Alternatively or in addition, the metric may be based in part on a frequency at which a user entered the respective query and did not select the initial resource. In some implementations the metric may be based on a combination or ratio of a frequency at which a user entered the respective query and selected the initial resource versus a frequency at which a user entered the respective query and did not select the initial resource. Then, in step 408, the processing system selects a subset of queries from the set of queries based on determining whether the metric associated with each query satisfies a threshold.

The processing system then associates the queries in the selected subset of queries with the classification of the initial query in step 410. The processing system then provides the selected subset of queries for inducing a grammar in step 412. The grammar may be used for semantic parsing related to the classification of the initial query. For example, the grammar generation engine 150 shown in FIG. 1 may extract a set of patterns from the selected subset of queries and then generate a grammar for semantic parsing based on the set of patterns.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A non-transitory computer-readable medium storing instructions executable by one or more computers having one or more processors which, upon such execution, cause the one or more computers to perform operations comprising:
accessing a seed query that is pre-associated with (i) a topic or (ii) a command to initiate an action;
obtaining a set of candidate queries that are each identified as having resulted in a selection, by one or more users, of a respective resource to which the seed query also resolves;
determining, at the one or more computers and for one or more candidate queries in the set of queries, a value that reflects a similarity between the respective candidate query and the seed query;
selecting, as a set of queries from which a grammar associated with (i) the topic or (ii) the command to initiate the action is to be automatically generated, a subset of candidate queries from the set of candidate queries based on the value for each selected candidate query satisfying a similarity threshold;
extracting a set of text patterns from the set of queries from which the grammar associated with (i) the topic or (ii) the command to initiate the action is to be automatically generated;
generating the grammar associated with (i) the topic or (ii) the command to initiate the action, for semantic parsing, based on the set of text patterns;
using, by a server-based, automated query processing engine, the grammar to process a subsequently received query; and
providing, by the automated query processing engine to the one or more computers, the result of processing the subsequently received query.

2-20. (canceled)

21. The computer-readable medium of claim 1,
wherein accessing the seed query that is associated with (i) the topic or (ii) the command to initiate an action comprises accessing an initial web search query pre-associated with (i) the topic or (ii) the command to initiate an action;
wherein obtaining the set of candidate queries that are each identified as having resulted in the selection, by one or more users, of the respective resource to which the seed query also resolves comprises obtaining a set of web search queries, wherein each query in the set of web search queries is identified as having resulted in one or more users selecting a web page that was selected by one or more users in response to submitting the initial web search query;
wherein determining, at the one or more computers and for one or more candidate queries in the set of queries, the value that reflects a similarity between the respective candidate query and the seed query comprises determining, at the one or more computers, a value that reflects a similarity between the respective candidate query and the seed query; and
wherein selecting, as the set of queries from which a grammar associated with (i) the topic or (ii) the command to initiate the action is to be automatically generated, the subset of candidate queries from the set of candidate queries based on the value for each selected candidate query satisfying a similarity threshold comprises selecting, at the one or more computers, a subset of web search queries from the set of web search queries based on the metric for each selected web search query satisfying a similarity threshold.

22. The computer-readable medium of claim 1,
wherein accessing the seed query that is pre-associated with (i) the topic or (ii) the command to initiate an action comprises accessing an initial command pre-associated with the command to initiate an action;
wherein obtaining the set of candidate queries that are each identified as having resulted in the selection, by one or more users, of the respective resource to which the seed query also resolves comprises obtaining a set of commands, wherein each command in the set of commands is identified as having resulted in one or more users selecting an action that was selected by one or more users during a session in which the one or more users submitted the initial command;
wherein determining, at the one or more computers and for one or more candidate queries in the set of queries, the value that reflects a similarity between the respective candidate query and the seed query, comprises determining, at the one or more processors, a value for one or more commands in the set of commands; and
wherein selecting, as the set of queries from which a grammar associated with (i) the topic or (ii) the command to initiate the action is to be automatically generated, the subset of candidate queries from the set of candidate queries based on the value for each selected candidate query satisfying a similarity threshold comprises selecting, at the one or more computers, a subset of commands from the set of commands based on the value for each selected command satisfying a threshold.

23. The computer-readable medium of claim 22, wherein obtaining the set of commands that are each identified as having resulted in a selection of the action that was selected by one or more users during the session in which the one or more users submitted the initial command comprises obtaining a set of commands, wherein each command in the set of commands is identified as having resulted in one or more users selecting an action that was selected by one or more users in response to submitting the initial command.

24. The computer-readable medium of claim 1, wherein determining, at the one or more computers and for one or more candidate queries in the set of queries, the value that reflects a similarity between the respective candidate query and the seed query comprises determining, at the one or more computers, a value for each query in the set of queries, wherein the value for each query in the set of queries is based on a cosine similarity between resources selected in response to the respective query and resources selected in response to the seed query.

25. A system comprising:
one or more computers and one or more storage devices storing instructions that are operable, when executed by the one or more computers, to cause the one or more computers to perform operations comprising:
accessing a seed resource that is pre-associated with (i) a semantic topic or (ii) a command to initiate an action;
obtaining a set of candidate queries that are each identified as having resulted in a selection, by one or more users, of a respective resource to which the seed query also resolves;
determining, at the one or more computers for one or more candidate queries in the set of queries, a value that reflects a level of correlation between the respective candidate query and the seed resource;
selecting, as a set of queries from which a grammar associated with (i) the topic or (ii) the command to initiate the action is to be automatically generated, a subset of candidate queries from the set of candidate queries based on the value for each selected candidate query exceeding a similarity threshold;
extracting a set of text patterns from the set of queries from which the grammar associated with (i) the topic or (ii) the command to initiate the action is to be automatically generated;
generating the grammar associated with (i) the topic or (ii) the command to initiate the action, for semantic parsing, based on the set of text patterns;
using, by a server-based, automated query processing engine, the grammar to process a subsequently received query; and
providing, by the automated query processing engine to the one or more computers, the result of processing the subsequently received query.

26. The system of claim 25, wherein determining, at the one or more computers for one or more candidate queries in the set of queries, a value that reflects a level of correlation between the respective candidate query and the seed resource comprises determining a value for one or more queries in the set of queries, wherein the value for each of the one or more queries in the set of queries is based at least in part on a frequency of users selecting the seed resource in response to the respective query.

27. The system of claim 25, wherein determining, at the one or more computers for one or more candidate queries in the set of queries, a value that reflects a level of correlation between the respective candidate query and the seed resource comprises determining a value for one or more queries in the set of queries, wherein the value for each of the one or more queries in the set of queries is based at least in part on a frequency of users selecting the seed resource in response to the respective query compared to a frequency of users selecting other resources in response to the respective query.

28. The system of claim 25,
wherein accessing the seed resource that is pre-associated with (i) a semantic topic or (ii) a command to initiate an action comprises accessing a webpage pre-associated with (i) a semantic topic or (ii) a command to initiate an action;
wherein obtaining the set of candidate queries that are each identified as having resulted in a selection, by one or more users, of a respective resource to which the seed query also resolves comprises obtaining a set of web search queries, wherein each web search query in the set of web search queries is identified as having resulted in one or more users selecting the webpage;
wherein determining, at the one or more computers and for one or more candidate queries in the set of queries, the value that reflects the level of correlation between the respective candidate query and the seed resource comprises determining a value for one or more web search queries in the set of web search queries, wherein the value for each of the one or more web search queries in the set of web search queries is based on a level of correlation between the respective web search query and the webpage; and
wherein selecting, as a set of queries from which a grammar associated with (i) the topic or (ii) the command to initiate the action is to be automatically generated, a subset of candidate queries from the set of candidate queries based on the value for each selected candidate query exceeding a similarity threshold comprises selecting a subset of web search queries from the set of web search queries based on the value for each selected web search query exceeding a similarity threshold.

29. The system of claim 25,
wherein accessing the seed resource that is pre-associated with (i) a semantic topic or (ii) a command to initiate an action comprises accessing an action pre-associated with the semantic topic;
wherein obtaining the set of candidate queries that are each identified as having resulted in a selection, by one or more users, of a respective resource to which the seed query also resolves comprises obtaining a set of commands, wherein each command in the set of commands is identified as having resulted in one or more users selecting the action during a session;
wherein determining, at the one or more computers and for one or more candidate queries in the set of queries, the value that reflects the level of correlation between the respective candidate query and the seed resource comprises determining a value for one or more commands in the set of commands, wherein the metric for each of the one or more commands in the set of commands is based on a level of correlation between the respective command and the action; and
wherein selecting, as a set of queries from which a grammar associated with (i) the topic or (ii) the command to initiate the action is to be automatically generated, a subset of candidate queries from the set of candidate queries based on the value for each selected candidate query exceeding a similarity threshold comprises selecting a subset of commands from the set of commands based on the value for each selected command exceeding a similarity threshold.

30. The system of claim 29, wherein obtaining the set of commands that are each identified as having resulted in a selection of the action during a session comprises obtaining a set of commands that are each identified as having resulted in one or more users selecting the action in response to submitting each respective command.

31. A computer-implemented method comprising:
accessing a seed query that is pre-associated with (i) a topic or (ii) a command to initiate an action;
obtaining a set of candidate queries that are each identified as having resulted in a selection, by one or more users, of a respective resource to which the seed query also resolves;
determining, at the one or more computers and for one or more candidate queries in the set of queries, a value that reflects a similarity between the respective candidate query and the seed query;
selecting, as a set of queries from which a grammar associated with (i) the topic or (ii) the command to initiate the action is to be automatically generated, a subset of candidate queries from the set of candidate queries based on the value for each selected candidate query satisfying a similarity threshold;
extracting a set of text patterns from the set of queries from which the grammar associated with (i) the topic or (ii) the command to initiate the action is to be automatically generated;
generating the grammar associated with (i) the topic or (ii) the command to initiate the action, for semantic parsing, based on the set of text patterns;
using, by a server-based, automated query processing engine, the grammar to process a subsequently received query; and
providing, by the automated query processing engine to the one or more computers, the result of processing the subsequently received query.

32. The method of claim 31,
wherein accessing the seed query that is pre-associated with (i) the topic or (ii) the command to initiate an action comprises accessing an initial web search query pre-associated with (i) the topic or (ii) the command to initiate an actiont;
wherein obtaining the set of candidate queries that are each identified as having resulted in the selection, by one or more users, of the respective resource to which the seed query also resolves comprises obtaining a set of web search queries, wherein each query in the set of web search queries is identified as having resulted in one or more users selecting a web page that was selected by one or more users in response to submitting the initial web search query;
wherein determining, at the one or more computers and for one or more candidate queries in the set of queries, the value that reflects a similarity between the respective candidate query and the seed query comprises determining, at the one or more computers, a value that reflects a similarity between the respective candidate query and the seed query; and
wherein selecting, as the set of queries from which a grammar associated with (i) the topic or (ii) the command to initiate the action is to be automatically generated, the subset of candidate queries from the set of candidate queries based on the value for each selected candidate query satisfying a similarity threshold comprises selecting, at the one or more computers, a subset of web search queries from the set of web search queries based on the metric for each selected web search query satisfying a similarity threshold.

33. The method of claim 31,
wherein accessing the seed query that is pre-associated with (i) the topic or (ii) the command to initiate an action comprises accessing an initial command associated with the command to initiate an action;
wherein obtaining the set of candidate queries that are each identified as having resulted in the selection, by one or more users, of the respective resource to which the seed query also resolves comprises obtaining a set of commands, wherein each command in the set of commands is identified as having resulted in one or more users selecting an action that was selected by one or more users during a session in which the one or more users submitted the initial command;
wherein determining, at the one or more computers and for one or more candidate queries in the set of queries, the value that reflects a similarity between the respective candidate query and the seed query, comprises determining, at the one or more processors, a value for one or more commands in the set of commands; and
wherein selecting, as the set of queries from which a grammar associated with (i) the topic or (ii) the command to initiate the action is to be automatically generated, the subset of candidate queries from the set of candidate queries based on the value for each selected candidate query satisfying a similarity threshold comprises selecting, at the one or more computers, a subset of commands from the set of commands based on the value for each selected command satisfying a threshold.

34. The method of claim 33, wherein obtaining the set of commands that are each identified as having resulted in a selection of the action that was selected by one or more users during the session in which the one or more users submitted the initial command comprises obtaining a set of commands, wherein each command in the set of commands is identified as having resulted in one or more users selecting an action that was selected by one or more users in response to submitting the initial command.

35. The method of claim 31, wherein determining, at the one or more computers and for one or more candidate queries in the set of queries, a value that reflects the similarity between the respective candidate query and the seed query comprises determining, at the one or more computers, a value for each query in the set of queries, wherein the value for each query in the set of queries is based on a cosine similarity between resources selected in response to the respective query and resources selected in response to the seed query.
